(19) United States
(12) Patent Application Publication
(10) Pub. No.: US 2007/0020156 A1
(43) Pub. Date: Jan. 25, 2007

(54) Device for cleaning gas mixtures, and method for producing it

(76) Inventors: Wolfgang Kraft, Stuttgart-Weilimdorf (DE); Karl-Hermann Friese, Leonberg (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/488,630

(22) Filed: Jul. 19, 2006

(30) Foreign Application Priority Data
Jul. 19, 2005 (DE) 10 2005 033 635.3

(51) Int. Cl. B01D 50/00; B01D 53/34

(52) U.S. Cl. 422/177; 55/523; 422/182

(57) ABSTRACT

A device for cleaning gas mixtures that contain particles, in particular for cleaning soot-laden exhaust gases of internal combustion engines, is described in which the device is embodied as a filter that has a porous surface of a sintered-metal-containing filter-supporting material that is exposed to the gas mixture to be cleaned. The sintered-metal-containing filter-supporting material has a catalytically active material component.

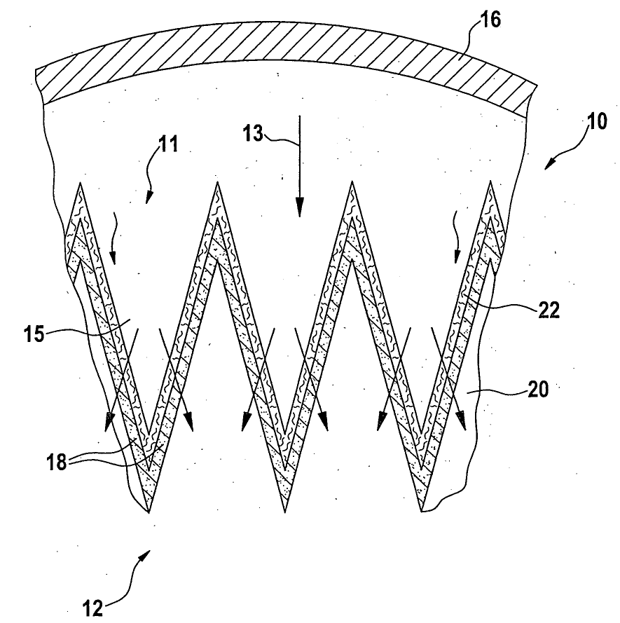

### REFERENCE TO FOREIGN PATENT APPLICATION

This application is based on German Patent Application No. 10 2005 033 635.3 filed 19 Jul. 2005, upon which priority is claimed.

### BACKGROUND OF THE INVENTION

1. Field of the Invention

The invention relates to a device for cleaning gas mixtures that contain particles, in particular for cleaning soot-laden exhaust gases of internal combustion engines, and to a method and a material powder for producing it, as well as to its use.

2. Description of the Prior Art

Cleaning exhaust gases that in particular contain carbon-laden particles is becoming increasingly important. For cleaning such gas mixtures, ceramic filter systems are typically used. The challenge to optimize such systems resides primarily not in the filtration itself—many particle filters make a filtration efficiency of more than 99% possible—but rather in the long-term efficient use of the filter without clogging, and without causing an excessive increase in the flow resistance over the entire filter system.

Recent filter systems, instead of a porous ceramic base body, have a filter element based on sintered metal. This has the advantage that the filter systems exhibit substantially more homogeneous filtration than conventional systems and can be used largely without maintenance. The porous structure of the metal body is generally created by sintered steel or sintered metal on the basis of metal powders, metal fibers and/or metal foams; incorporated metal supporting bodies, such as wire cloth, expanded metal or perforated metal, provides the mechanical stability. Such porous metal bodies can be found for instance in German Patent Disclosures DE 38 18 281, DE 39 08 581 and DE 41 10 285, as well as U.S. Pat. No. 5,679,441 and Japanese Patent Disclosure JP-A 8 089 728.

In some cases, however, it is problematic solely by sintering loose sintered metal powders, for instance in a heatproof form, to arrive at stable filter elements. In those cases; an organic binder is used, in order to stabilize the contour of the green compact. However, the use of such a binder has the disadvantage that in the sintering of the filter body, residues of the binder remain in the material and can lead to unwanted carbonization of the metal material.

### OBJECT AND SUMMARY OF THE INVENTION

The primary object of the present invention is to furnish an improved device for cleaning gas mixtures that contain particles, the device being embodied of a material that contains sintered metal and having a long service life.

The object of the invention is advantageously attained by the device, method, and metal powder of the invention which is embodied as a filter, has a porous surface, comprises a sintered-metal-containing filter-supporting material, that is exposed to the gas mixture to be cleaned, and the sintered-metal-containing filter-supporting material includes a catalytically active material component.

The catalytically active component as an ingredient in the filter-supporting material means that in the production of the filter, in the context of which sintering of a starting material is contemplated, the organic binder that may be contained in the starting material is expelled completely from the resultant filter-supporting material. If the organic binder were not completely removed, there would be the risk of unwanted carbonization of the metal constituents of the filter-supporting material.

It is accordingly advantageous if the catalytically active material component is contained in the form of nanoparticles in the filter-supporting material, since in this way the catalytically active material component simultaneously favorably influences the flow behavior of the sintered metal powder admixed with it, and thus the addition of other additives that influence the flow behavior can be dispensed with.

It is furthermore advantageous if the catalytically active material component is contained in the form of particles in the filter-supporting material that have a BET surface area of more than 70 m²/g. Since the catalytic activity of a material is a function, among other factors, of its effective surface area, if slight quantities of the catalytically active material are added, an effective expulsion of the organic binder during the production process can thus be achieved.

As the catalytic material, substances which have a sufficient capacity for reversible oxygen storage have proved especially suitable. This is the case for instance with oxides of cerium and/or of zirconium.

It is also advantageous if during the production of the filter, a heat treatment is done of a starting mixture which contains a sintered metal powder and the catalytically active material; first, the sintered metal powder is mixed with the powdered catalytic material, and the mixture is blended with an organic binder. Since the sintered metal powder and the catalytically active material are mixed together in the dry state, the catalytically active material can additionally function as a flow agent and facilitate the metering of the mixture of the sintered metal and the catalytically active material.

The device of the invention is advantageously suitable for use as a diesel particle filter.

### BRIEF DESCRIPTION OF THE DRAWING

The invention will be better understood and further objects and advantages thereof will become more apparent from the ensuing detailed description of a preferred embodiment taken in conjunction with the single drawing FIGURE which schematically shows a device in the form of a filter, in one exemplary embodiment of the invention.

### DESCRIPTION OF THE PREFERRED EMBODIMENTS

The basic construction of a device according to the invention for cleaning gas mixtures is preferably embodied as a filter, as is schematically shown in the drawing. The filter is integrated into a system in which a gas mixture, laden with preferably combustible particles, is carried. This can for instance be the exhaust line of a diesel engine. Alternatively, the capability exists of disposing the filter in a bypass around the exhaust gas-carrying system.

The filter 10 shown in the drawing is preferably embodied as a sintered metal filter, or a filter containing sintered metal, and has a first side 11, facing toward the gas mixture to be cleaned, and a second side 12, facing toward the cleaned gas mixture. The gas mixture 13, laden with particles, especially soot, is delivered to the filter 10 on its first side 11. The filter 10 includes a housing 16, into which the actual filter structure is integrated. The filter structure includes pockets 15, which are opened on their end toward the first side 11 for the entry of the particle-laden gas mixture and are closed on their end toward the second side 12. The pockets 15 are preferably bounded on their long sides by walls 18 that are porous, so that they allow the gas mixture to pass through, while trapping the particles contained in the gas mixture.

The gas mixture penetrating the walls 18 reaches second pockets 20, which are closed on their end toward the first side 11 and open on their end toward the second side 12, so that the gas mixture, freed of particles, can escape. To enlarge the filter-active surface area of the walls 18, these walls may be provided at least in part but preferably over their full surface with a surface coating 22, for instance comprising ceramic fibers.

The walls 18 are embodied of a filter-supporting material, which comprises or contains a sintered metal. During the production process, the filter-supporting material is created by subjecting a starting mixture, which contains the sintered metal, an organic binder, and a catalytically active material, to shaping to form a green compact. The green compact is then taken to a heat treatment for forming the walls 18, in which treatment the organic binder decomposes, and the gases released lead to the development of pores in the walls 18 that are created. However, an unwanted side effect can occur in the form of carbonization of the metal material of the walls 18. This is effectively prevented by the addition of a catalytically active material, which catalyzes the burnoff of the organic binder during the heat treatment.

The action of the catalytically active material in the filter-supporting material is based in particular on the fact that during the heat treatment, the organic binder is decomposed into low-molecular substances, or an at least partial oxidation of the organic binder is brought about. As the catalytically active material, substances that are capable of binding or giving off oxygen reversibly, or that have a high density of surface redox centers, are especially suitable. These latter are oxides of cerium or zirconium, or the mixed oxides thereof, such as CeₓZrₗ₋ₓO₂, where 0.15<x<1, and in particular 0.4<x<1. The filter-supporting material of the walls 18 for instance has from 0.1 to 5 weight %, in particular 0.1 to 2 weight %, of the catalytically active material.

The starting mixture on which the production process is based is furnished by for instance first producing a mixture of a sintered metal powder with a suitable catalytically active material. The mixture ingredients are preferably mixed intensively with one another, for instance in a tumble mixer. After that, the addition of an organic binder is done, such as wax, polyvinyl acetate or polyvinyl alcohol. The binder can be added in the form of a powder, granulate, solution, or emulsion. As a solvent or emulsifier, water or organic liquid media such as terpineol, alcohols, and so forth can be considered. The binder is preferably added in a proportion of 0.5 to 10 weight %, preferably 1 to 5 weight %, and particular 1 to 2 weight %, to the starting mixture.

Since the sintered metal powder and the catalytically active material are mixed together in the dry state, the catalytically active material can additionally function as a flow agent and facilitate the metering of the mixture of the sintered metal and the catalytically active material. Alternatively, however, the catalytically active material can also be added in the form of a suspension in an organic or aqueous solvent. A further alternative is first to put the sintered metal, the catalytically active material, and the organic binder together and then to subject the mixture to an intensive thorough mixing process.

Instead of adding the catalytically active material, precursor compounds of it can be added, for instance in the form of hydroxides of the elements cerium, zirconium, etc. The precursor compounds then react during the heat treatment, forming the catalytically active material.

The catalytically active material is preferably used in the form of nanoparticles, since in this way the catalytically active material component simultaneously favorably influences the flow behavior of the admixed sintered metal powder, and thus the addition of other additives that influence the flow behavior, such as flame-hydrolytically produced silicon dioxide, can be dispensed with. Moreover, the catalytically active material is added for instance in the form of particles that have a BET surface area of more than 70 m²/g, preferably 80 to 180 m²/g, and in particular 90 to 120 m²/g. In this way, an adequate catalytic activity of the catalytically active material is assured.

The starting mixture created is then preferably placed on a high-temperature-stable metal substrate that acts as a supporting body and that is embodied for instance as a wire cloth, expanded metal, or perforated sheet metal.

Finally, a heat treatment of the supporting body coated with the starting mixture is performed. The heat treatment is preferably done in two phases; in the first phase, a burnoff of the organic binder is done, preferably at temperatures of up to 650° C., and in a second phase, a sintering process is done at temperatures of up to 1150° C. to 1250° C. The binder burnoff takes place in a reducing furnace atmosphere, for instance in the presence of hydrogen, in an inert furnace atmosphere, for instance in argon, or in an oxidizing atmosphere, such as a mixture of oxygen and argon. It is moreover possible to add steam to the furnace atmosphere, in order to reinforce the binder burnoff.

The foregoing relates to a preferred exemplary embodiment of the invention, it being understood that other variants and embodiments thereof are possible within the spirit and scope of the invention, the latter being defined by the appended claims.

We claim:

1. A device for cleaning gas mixtures that contain particles, in particular for cleaning soot-laden exhaust gases of internal combustion engines, the device being embodied as a filter and comprising a porous surface of a sintered-metal-containing filter-supporting material that is exposed to the gas mixture to be cleaned, and a catalytically active material component contained in the sintered-metal-containing filter-supporting material.

2. The device as defined by claim 1, wherein the catalytically active material component is contained in the form of nanoparticles in the filter-supporting material.

3. The device as defined by claim 1, wherein the catalytically active material component is contained in the form of particles in the filter-supporting material that have a BET surface area of more than 70 m²/g.

4. The device as defined by claim 2, wherein the catalytically active material component is contained in the form of particles in the filter-supporting material that have a BET surface area of more than 70 m²/g.

5. The device as defined by claim 1, wherein the catalytically active material component contains an oxide of cerium and/or of zirconium.

6. The device as defined by claim 1, wherein the filter-supporting material contains no silicon compounds.

7. The device as defined by claim 2, wherein the filter-supporting material contains no silicon compounds.

8. The device as defined by claim 3, wherein the filter-supporting material contains no silicon compounds.

9. A method for producing a device as defined in claim 1, for cleaning gas mixtures that contain particles, the device being embodied as a filter having a porous surface that is exposed to the gas mixture to be cleaned, the filter comprising of a filter-supporting material which is obtained by heat treatment of a starting mixture that contains a sintered metal powder and a catalytically active material.

10. The method as defined by claim 9, wherein first, the sintered metal powder is mixed with the powdered catalytic material, and the mixture is then charged with an organic binder.

11. The method as defined by claim 9, wherein first, the powdered catalytic material is charged with a solvent and/or a binder and then is mixed with the sintered metal powder.

12. The method as defined by claim 9, further comprising adding a precursor material of the catalytic material to the starting mixture.

13. The method as defined by claim 10, further comprising adding a precursor material of the catalytic material to the starting mixture.

14. The method as defined by claim 11, further comprising adding a precursor material of the catalytic material to the starting mixture.

15. The method as defined by claim 9, wherein the heat treatment comprise a treatment at a temperature of up to 650° C. for expelling the organic binder and an ensuing sintered process at temperatures of from about 1000° C. to about 1350° C.

16. The method as defined by claim 10, wherein the heat treatment comprise a treatment at a temperature of up to 650° C. for expelling the organic binder and an ensuing sintered process at temperatures of from about 1000° C. to about 1350° C.

17. The method as defined by claim 11, wherein the heat treatment comprise a treatment at a temperature of up to 650° C. for expelling the organic binder and an ensuing sintered process at temperatures of from about 1000° C. to about 1350° C.

18. A material powder, suitable for producing a device as defined by claim 1, containing a sintered metal powder and a catalytically active material.

19. The material powder as defined by claim 18, wherein the catalytically active material component is an oxide of cerium and/or of zirconium.

20. The use of a device as defined by claim 1, as a diesel particle filter.
